(19) United States
(12) Patent Application Publication
(10) Pub. No.: US 2026/0043487 A1
(43) Pub. Date: Feb. 12, 2026

(54) DISTRIBUTOR HAVING AN INCORPORATED SEAL AND METHOD FOR PRODUCING SAME

(71) Applicant: BONTAZ CENTRE, MARNAZ (FR)

(72) Inventors: Anthony TAUPEAU, Saint-Jorioz (FR); Stéphane CALLAMAND, Marnaz (FR); Nicolas VIROT, Bonneville (FR)

(21) Appl. No.: 18/998,770

(22) PCT Filed: Jul. 26, 2023
(86) PCT No.: PCT/FR2023/051162

§ 371 Date: Jan. 27, 2025

(30) Foreign Application Priority Data
Jul. 27, 2022 (FR) 2207735

(51) Int. Cl. F16K 11/085; F16K 5/04; F16K 31/04

(52) U.S. Cl. CPC F16K 11/085; F16K 5/0414; F16K 5/0478; F16K 31/041

(57) ABSTRACT

A hydraulic rotary distributor including a case and a core, the case comprising a lateral wall, two end walls defining a hydraulic chamber, wherein the core capable of rotating in the chamber about an axis of rotation is housed, at least one supply orifice, and at least one outlet orifice, the core including a lateral surface, an inlet opening, at least one lateral outlet and a duct or a chamber that connects the inlet opening and the lateral outlet and that allows a supply of each of the outlet orifices according to the angular position of the core in the case, the core further including at least one non-removable seal, against the lateral surface of the core, each seal also including one or more fastening and/or injection lug(s) in the lateral surface of the core, the lugs forming one piece with the seal.

The present invention relates to a rotary valve or to a hydraulic distributor, for example used for cooling in the automotive industry, the valve or distributor preferably being electrically actuated. The invention also applies to the distribution of a coolant of a fuel cell.

In the automotive field, the use of valves or of hydraulic distributors is routine for cooling certain parts of the engine, for example these are motorised valves with 1 or 2 inlet(s) and 2 outlets and a solenoid valve with 1 inlet and 2 outlets. These valves or distributors are generally controlled via an electric motor.

There are several types of hydraulic valves or distributors (the following description uses the term “distributor”, but it must be understood as also applying to a valve), in particular slide valves and rotary distributors.

Rotary distributors, also called ball and plug distributors, include a case defining a chamber in the shape of a cylinder of revolution provided with at least one fluid inlet intended to be connected to a source of liquid, and at least one fluid outlet intended to be connected to a pipe to bring the liquid towards the zone to be cooled. The inlet and the outlet open into the cylindrical wall of the chamber. The distributor also includes a rotating central part or core mounted in the chamber. The core includes an outer surface of revolution facing the cylindrical wall of the chamber. The core includes at least two orifices in its outer surface connected by a channel. The two orifices are oriented with respect to one another so that, when one of the orifices is facing the inlet, the other is facing the outlet. Thus, by turning the core in the chamber, it is possible to allow or interrupt the circulation between the inlet and the outlet and thus the circulation between the source of liquid and the zone to be cooled.

In such a distributor, sealing between the core and the case is usually obtained by using seals: the device must therefore provide grooves wherein these seals are positioned. This results in a device and a production method that are complex. It is sought precisely to create distributors with a simple, reliable design and including a reduced number of components.

The problem of producing such a distributor in a simpler manner than with known methods, implementing fewer manufacturing steps, also arises. In particular, a method not requiring a step of assembling each seal with the core is sought.

### DESCRIPTION OF THE INVENTION

Therefore, one aim of the present invention is that of providing a reliable rotary hydraulic distributor with simplified manufacturing with respect to the hydraulic distributors of the prior art.

The invention thus also relates to a hydraulic rotary distributor including a case and a core, said case comprising a lateral wall, two end walls defining a hydraulic chamber, wherein the core capable of rotating in said chamber about an axis of rotation (XX′) is housed, at least one supply orifice, and at least one outlet orifice, which open(s) into the hydraulic chamber, the core including a lateral surface facing the lateral wall of the case, an inlet opening, at least one lateral outlet and a duct that connects said inlet opening and said lateral outlet and that allows a supply of each of said outlet orifices according to the angular position of the core in the case.

The core furthermore includes at least one seal for sealing, or to ensure sealing, between the lateral surface of the core and an outlet orifice (or corresponding outlet orifice) of the lateral wall of the case. Each seal can be moulded on or with the core and/or integrated in the core and/or non-removable with respect to the core. For example, each seal is connected to, or is directly bonded with, the lateral surface of the core by chemical and/or mechanical bonding. Each seal is disposed to seal one of the outlet orifices in a given position of the core.

According to one embodiment, each seal can include one or more fastening and/or injection lug(s) in the lateral surface of the core. The lug(s) very advantageously form(s) one piece with the seal.

In such a device (or in its manufacturing method), each lug preferably results from the same method or the same step of manufacture as the seal.

According to a particular embodiment, the lateral surface of the core includes at least one hollow housing, each containing or receiving said seal or one of said seal(s). Such a hollow housing can be provided for each seal, each containing or receiving a different seal.

For example, at least one, or each, housing includes a recessed zone, preferably disposed centrally with respect to the housing, located recessed with respect to the outer surface of the core, and which helps seal the outlet orifice.

At least one housing, or each housing, can include an element, referred to as holding element, extending from a bottom surface of the housing, preferably disposed centrally with respect to the latter, and helping hold a seal in the housing.

At least one, or each, seal can include a lip forming a closed contour and of minimum size greater than that of the outlet orifice that corresponds to this seal.

In a hydraulic rotary distributor according to the invention:
the case can be made of plastic material;
and/or at least one, or each, seal, is made of a material capable of being used for an injection method, for example an elastomeric material;
and/or the core is made of thermoplastic material, of PPS (polyphenylene sulphide), or PA (polyamide) or POM (polyoxymethylene or polyformaldehyde or polyacetal), or PA66 (polyamide incorporating nylon) type.

According to a particular embodiment of a hydraulic rotary distributor according to the invention:
at least one supply orifice is in one of the end walls of the case and extends substantially perpendicularly to said axis of rotation;
or said at least one supply orifice is in the lateral wall of the case.

According to a particular exemplary embodiment of a hydraulic rotary distributor according to the invention, the lateral wall of the case includes a plurality of outlet orifices, the core including a plurality of seals for sealing, or to ensure sealing, between the lateral surface of the core and one of the outlet orifices of the lateral wall of the case, each seal being non-removable with respect to the core and being disposed to seal one of the outlet orifices in a given position of the core.

For example, in such a hydraulic rotary distributor, the lateral wall of the case includes 2 outlet orifices, the core including 2 seals for sealing, or to ensure sealing, between the lateral surface of the core and one of the 2 outlet orifices of the lateral wall of the case, each seal being non-removable with respect to the core and being disposed to seal one of the 2 outlet orifices in a given position of the core.

Preferably, each of the 2 seals is disposed on one side of the lateral outlet of the core; the latter can therefore be located between 2 seals.

The invention also relates to a hydraulic rotary solenoid distributor including a distributor according to the invention and an actuator driving the core in rotation.

The actuator includes for example an output shaft aligned along the axis of rotation.

The invention also relates to a method for manufacturing a hydraulic rotary solenoid distributor according to the invention, this method including:
a step of bi-material injection of an assembly including the core and the seal(s);
a step of introducing the core and the seal(s) into the case.

In such a method:
at least one, or each seal, can be made of an elastomeric material;
and/or the core is made of thermoplastic material, of PPS (polyphenylene sulphide), or PA (polyamide) or POM (polyoxymethylene or polyformaldehyde or polyacetal), or PA66 (polyamide incorporating nylon) type.

The invention also relates to a method for distributing a fluid using a hydraulic rotary solenoid distributor according to the invention, the fluid being introduced by the supply orifice, and being guided by the inner duct of the core towards the lateral orifice of the latter then, according to the orientation of the core in the case, towards one and/or the other of the outlet orifices.

According to one example, the fluid is a mixture of water and of glycol, for example of water at 60% and glycol at 40%.

This fluid can be, for example, a coolant of a fuel cell.

### BRIEF DESCRIPTION OF THE DRAWINGS

The present invention will be better understood on the basis of the following description and the appended drawings wherein:

FIG. 1 is a sectional view of an example of a hydraulic rotary distributor to which the invention can be applied, this distributor including one inlet and two outlets.

FIG. 2A is a perspective view of the rotary central part of the distributor of FIG. 1.

FIG. 2B is a front view of the rotary central part of the distributor of FIG. 1.

FIG. 2C is a sectional view of the rotary central part of the distributor of FIG. 1.

FIG. 3 is a side view of the duct of the rotary central part of the distributor of FIG. 1.

FIG. 4 is a sectional top view of the case and the core of the distributor, allowing a partial flow to each of the 2 outlet passages.

FIG. 5A is a sectional top view of the case and the core of the distributor in a 1^{st} switching state, allowing a flow only to one of the 2 distributor outlet passages.

FIG. 5B is a sectional top view of the case and the core of the distributor in a 2^{nd} switching state, allowing a flow only to the other of the 2 distributor outlet passages.

FIG. 6 is a view of a compartment of a lower portion of the core for receiving means for coupling with a shaft of an actuator.

FIG. 7A is a sectional view of an exemplary embodiment of the coupling means for coupling the core with a shaft of an actuator.

FIG. 7B is a view of another exemplary embodiment of the coupling means for coupling the core with a shaft of an actuator.

FIG. 8 is a view illustrating an embodiment of return means for bringing the core back into an initial position.

FIG. 9A is a view of a distributor according to the invention, with an axial supply.

FIG. 9A is a sectional view of a rotary valve according to the invention, with an axial supply.

FIG. 10A

FIG. 10B

FIG. 10C represent steps of producing a core of a rotary hydraulic distributor according to the invention.

FIG. 11A is a sectional top view of a radial-supply distributor, in a 1^{st} core position;

FIG. 11B is a sectional top view of a radial-supply distributor, in a 2^{nd} core position.

### DETAILED DESCRIPTION OF SPECIFIC EMBODIMENTS

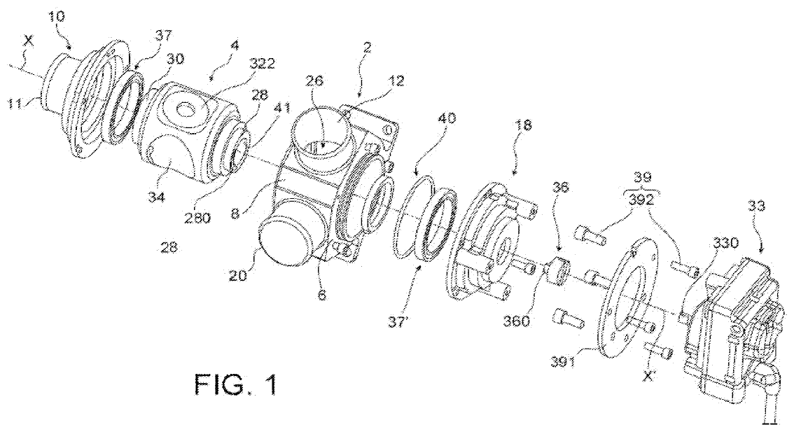

In FIG. 1, an exemplary embodiment of a rotary hydraulic distributor to which the invention can be applied, can be seen. This distributor includes an inlet and two outlets. It will be understood that the distributor can include one or more inlets and/or one or more outlets.

The distributor D includes a case 2 or valve body, having substantially the shape of a cylinder of revolution about the axis XX′, and a central part 4, called core, mounted in the case 2 and capable of rotating in the latter.

In the example shown, the case 2 includes a bottom 6 and a substantially cylindrical one-piece lateral wall 8, and an inlet cover 10 which includes an opening 11 by which the fluid enters the device; in this example, the fluid thus flows along a direction aligned with the axis XX′, then is distributed, by the core 4, towards one or more lateral outlet(s) of the case. The inlet cover 10 is for example assembled or rigidly connected to the case 2 in a removable manner, for example by screws, or in a fixed manner, for example by welding, also for example by ultrasound welding (in particular if the parts are made of plastic material).

It should be noted that the coaxial arrival of the fluid makes it possible to reduce the torque produced thereby on the entire distributor. This is advantageous regardless of the flow rate of the fluid, but especially for high flow rates, for example between 200 and 700 litres per minute. The case 2 includes a first outlet orifice 20 formed in the lateral wall 8, which can be extended by a 1^{st} duct (not shown in the figure) intended for example to bring the liquid towards a given zone, for example a zone to be cooled, and a second outlet orifice 12, which can be extended by a 2^{nd} duct (not shown in the figure) also intended for example to bring the liquid towards another given zone, for example also a zone to be cooled. These ducts are assembled, for example by welding or using a clamping collar, on the base of the orifices 12 and 20. The case 2 defines a hydraulic chamber 26. The outlet orifices 12 and 20 are distributed angularly on the lateral wall about the axis XX′.

The case 2 also includes a motor cowl 18, which can be for example assembled or rigidly connected to the case 2 in a removable manner, for example by screws, or in a fixed manner, for example by welding, also for example by ultrasound welding (in particular if the parts are made of plastic material). These 2 parts (cowl and case) can be of one piece, for example if an injection or moulding technique is used to produce them. All of the device is actuated by an actuator 33 (for example a motor or a gear motor). Coupling means, or a member, 36 connect a shaft of the actuator to the core 4 in order to drive the latter in rotation about the axis XX′.

Adaptation means 39, including for example a crown 391 and fastening means 392, for example screws, can be provided to assemble the actuator 33 with the cowl 18. The axis of the actuator passes through the central orifice of the crown.

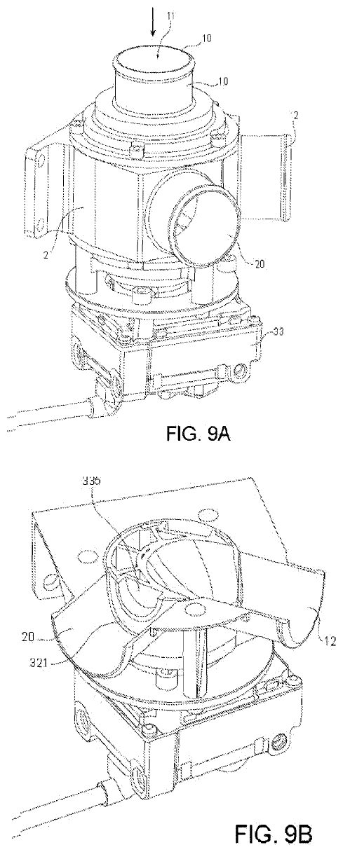

The device of FIG. 1 is shown assembled in FIG. 9A.

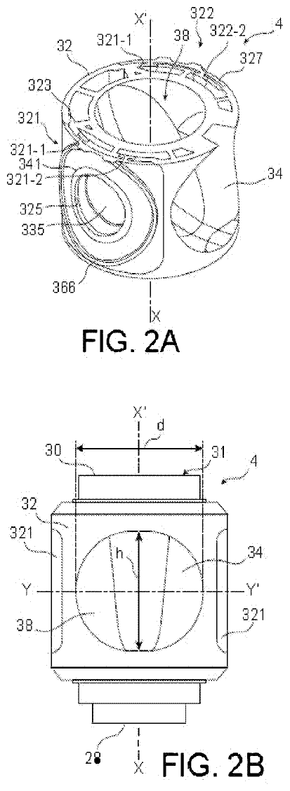

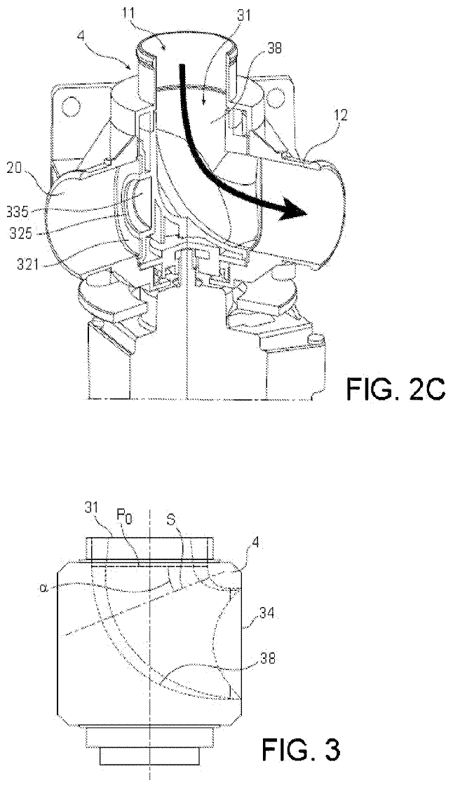

FIGS. 2A-2C show the core 4 also having the shape of a cylinder of revolution with axis XX′. FIG. 2A is a cross-section of the core along a plane perpendicular to the axis XX′. This core 4 is mounted in the hydraulic chamber, in which it is capable of rotating about the axis XX′. It includes two end faces 28, 30 and a lateral surface 32, which is provided with parts 321, 322 forming a seal (these parts are described hereinafter), each being provided to seal one of the outlet orifices 12 and 20, according to the position of the core about the axis XX′.

When this core 4 is mounted in the hydraulic chamber, its end face 28 is facing the bottom of the case 2 (located on the actuator side) and its end face 30 is facing the cover 10. The end face 30 includes an opening 31 (FIGS. 2B and 2C) intended to be aligned with the opening 11 of the cover 10 in order to receive the flow of fluid which flows along the axis XX′. The lateral surface 32 of the core 4 includes a lateral opening 34, which will make it possible to guide the fluid towards one or more of the outlet orifices 12, 20, according to the position of the core about the axis XX′. A ball bearing 37 can be provided, to ensure the guiding in rotation of the core 4 in the case 2; moreover, a static seal can advantageously be provided between the case 2 and the cover 10 to avoid leaks of liquid. Likewise, one or more seal(s) 40 is/are advantageously provided between the end face 6 and the cowl 18 to avoid leaks of liquid. The reference 37′ also designates a ball bearing. A duct 38, inside the core 4, connects the opening 31 for inlet of the fluid into the core 4 and the opening 34 for outlet of the fluid from the core. An example of the shape of this duct is shown in more detail in FIG. 3 and explained hereinafter.

The core 4 also includes (see FIGS. 2A-2C and 9B):
a first seal 321, around one, or in one, so-called sealing, zone of the lateral face of the core 4, intended to seal the outlet orifice 12, when this zone and this outlet orifice 12 are facing each other,
and a second seal 322 (seen in FIG. 2B but not in FIG. 2C), around one, or in one, also so-called sealing, zone of the lateral surface of the core 4, intended to seal the outlet orifice 20, when this zone and this outlet orifice 20 are facing each other.

The first seal 321 and the second seal 322 can be of identical or similar shape, as well as the mounting thereof on the core.

The first seal 321 is in a hollow housing 323 formed in the lateral surface of the core 4.

The shape of the housing 323 matches the shape of this first seal 321: the outer surface of the seal extends, or is flush with, the lateral surface 32 of the core 4.

The housing 323 can include:
a zone 335, preferably planar and/or disposed centrally with respect to the housing, preferably located recessed with respect to the outer surface of the core, or with respect to the surface against which the seal is disposed, and which helps seal the outlet orifice 12; this recessed zone 335 has for example a circular or disk shape;
and/or, at its centre, an element 325, referred to as holding element, extending from the bottom of the housing 323, preferably disposed centrally with respect to the latter, for example from the recessed zone 335, and helping hold the seal 321 in the housing.

This holding element has for example a circular shape.

The second seal 322 is also in a hollow housing 327 formed in the lateral surface of the core 4. The shape of the housing 327 matches the shape of the second seal 322: the outer surface of the seal extends, or is flush with, the lateral surface 32 of the core 4.

As for the housing 323, the housing 327 can include:
a zone, identical or similar to the zone 335, preferably planar and/or disposed centrally with respect to the housing 327, preferably located recessed with respect to the outer surface of the core, and which helps seal the outlet orifice 20; this recessed zone has for example a circular or disk shape;
and/or at its centre an element, referred to as holding element, extending from the bottom of the housing 327, preferably disposed centrally with respect to the latter, for example from the recessed zone, and helping hold the seal 322 in the housing at its centre. This holding element has for example a circular shape.

The first and second housings 323, 327 receiving the seals and the duct 38 are disposed in such a way as to allow a selective flow between the outlet 34 of the duct 38 and one and/or the other of the outlet orifices 12, 20 by modifying the angular position of the core 4 about the axis X.

The first seal 321 and the second seal 322 are mounted in the core with respect to each other in such a way that:
in a 1^{st} position (shown in FIG. 2C), the housing 323, including the first seal 321, is facing the outlet orifice 20 and completely interrupts the liquid flow from the supply orifice towards this outlet orifice 20, the liquid then flowing towards the other outlet orifice 12;
and, in a 2^{nd} position (not shown), the housing 327, including the first seal 322, is facing the outlet orifice 12 and completely interrupts the liquid flow from the supply orifice towards this outlet orifice 12, the liquid then flowing towards the other outlet orifice 20.

As can be understood from FIG. 2C, around the outlet orifices, the seals come into contact with the inner face of the chamber 26.

In this example, the seals 321, 322 each have a substantially square (seen in FIG. 2A for the seal 321) or rectangular shape, the angles of which can be rounded; alternatively, the seals can be of circular shape (or have any other shape).

Each of the seals 321, 322 can include a through hole 341 (not shown for the seal 322) passed through by the holding element 325. The shape of the cross-section of the hole 341 matches the outer shape of the cross-section of the holding element 325, and their dimensions are such that the outer surface of the holding element 325 comes into contact with the inner surface of the hole 341 so as to ensure a sealed contact (the same description applies for the seal 322).

Preferably, each of the seals 321, 322 includes:
a protruding element 366 (not shown for the seal 322) forming a closed contour around the outlet orifice that it is intended to seal, or around the hole 341, so as to form a continuous lip or bead around this orifice or this hole 341. In the example shown, the lip 366 is annular;
and/or one or more lateral lugs or pad(s) 321-1, 321-2, 322-1, 322-2, located in the wall of the core, which can result from an injection or moulding process, and which help(s) hold the seal in its housing 323, 327 and/or which result(s) from the injection method. The internal diameter, or the smallest internal dimension, of the lip 366 is greater than the diameter, or the greatest dimension, of the outlet orifice 20 that the corresponding seal is intended to seal. Preferably, the lip 366 has a shape corresponding to the outer contour of the outlet orifices 20 and 12. If the outlet orifices has an ellipse shape, the lip 366 would preferably likewise have an elliptical shape.

Preferably:
each of the seals 321, 322 is made of a material capable of being used for an injection method, for example, it is an elastomeric material; one example is THERMOLAST® V TV6VAN (Series LTP/PA) from Kraiburg TPE, which can have a hardness of 60 Shore A (DIN ISO 48-4), and a density of 0.930 g/cm³ (DIN EN ISO 1183-1), other properties being available on www.kraiburg-tpe.com;
the core 4 is made of thermoplastic material, for example of PPS (polyphenylene sulphide), or PA (polyamide) or POM (polyoxymethylene or polyformaldehyde or polyacetal), or PA66 (PA with nylon) type;

Thus, the assembly including the core 4 and the seals 321, 322 can be produced with a bi-material injection method (similar to overmoulding). This makes it possible to produce this assembly in a single method and not have to perform the mounting of a removable seal in an orifice provided for this purpose in the core.

The assembly including the core 4 and the seals 321, 322, forms one piece, the seals not being removable with respect to the core or detachable from the latter. The seals are connected to the core by a joints by chemical bonding or gluing and/or by one or more of the lateral lugs 321-1, 321-2, 322-1, 322-2, helping hold the seal firmly in position in its housing, including during rotation movements of the core in the case. This assembly can then be introduced into the case, which can in turn be produced with an injection and/or moulding technique, for example by plastic injection.

A preferred shape of the duct 38 is shown in more detail in FIG. 3, wherein it is seen that this duct can widen, from the inlet opening 31, which is for example circular, towards the outlet opening 34, which preferably has an elongated shape as explained hereinafter. A plane P, substantially orthogonal to the direction of flow of the fluid, is shown in FIG. 3: this plane P makes an angle α with a plane P₀, parallel to the plane in which the inlet opening 31 is located. The intersection of this plane P with the duct 38 has a surface area S, which can increase, for example in a linear manner, as the angle α increases. This progressive increase allows a reduction in the head losses.

The table below indicates, for different values of the angle α, different values of the surface area S which, as already indicated above, increases as the angle α increases.

TABLE

| | Section | Deviation from | Deviation from |
|---|---|---|---|
| Position | (mm²) | the previous | the initial |
| 0° | 2017.91 | | |
| 10° | 2045.51 | 1% | 1% |
| 20° | 2081.97 | 2% | 3% |
| 30° | 2125.2 | 2% | 5% |
| 40° | 2173 | 2% | 8% |
| 50° | 2223.02 | 2% | 10% |
| 60° | 2272.66 | 2% | 13% |
| 70° | 2319.19 | 2% | 15% |
| 80° | 2359.7 | 2% | 17% |
| 90° | 2391.16 | 1% | 18% |
| Final | 2412.57 | 1% | 20% |

In its final part, while the angle α is equal to 90°, the surface area S can further increase as understood from the above table (see the difference between the value of S for 90° and the “final” value).

For example, for each increase of the angle α by 10°, or more generally between 7° and 12°, the surface area S can increase by a relative value between 1 and 3%, for example 2%.

Preferably, the outlet orifice 34 has, in projection in a plane parallel to the axis XX′ and perpendicular to the direction of outlet of the fluid, an elongated or oblong shape along an axis YY′ substantially perpendicular to the axis XX′. For example, this projection of the outlet orifice has an ellipsoid shape, the longer axis of the ellipsoid being the same as the axis YY′.

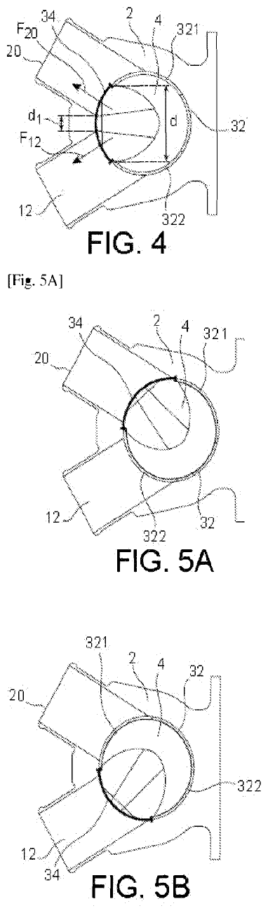

The distance d (FIG. 2B) between the points farthest from this opening along the axis YY′ is preferably greater than the distance di that separates 2 neighbouring outlet openings 12, 20 of the rotary case 2, as illustrated in FIG. 4, which shows, schematically, the case 2, with its 2 outlets 12, 20 and the core 4 with its outlet orifice 34. In FIG. 4, the latter partially opens onto the outlet 12 and partially onto the outlet 20, thus allowing a 1^{st} flow F12 to flow through the outlet 12 and a 2^{nd} flow F20 to flow through the outlet 20. The ratio of these flows can be modified by modifying, using the actuator 33, the orientation of the core 4 in the case 2: for several positions of the core, the orifice 34 opens partly onto the outlet 12 and partly onto the outlet 20 and, for each of these positions, the ratio of these flows is different from what it is in other positions. In FIG. 4, the seals 321, 322 are shown, none of them completely sealing one of the outlet passages 12, 20.

In certain positions, the outlet orifice 34 can open only into one or the other of the outlets 12, 20. This is shown FIGS. 5A (flow outlet entirely towards the outlet 20, the part of the core 4 that includes the seal 322 completely sealing the outlet passage 12) and 5B (flow outlet entirely towards the outlet 12, the part of the core 4 that includes the seal 322 completely sealing the outlet passage 20).

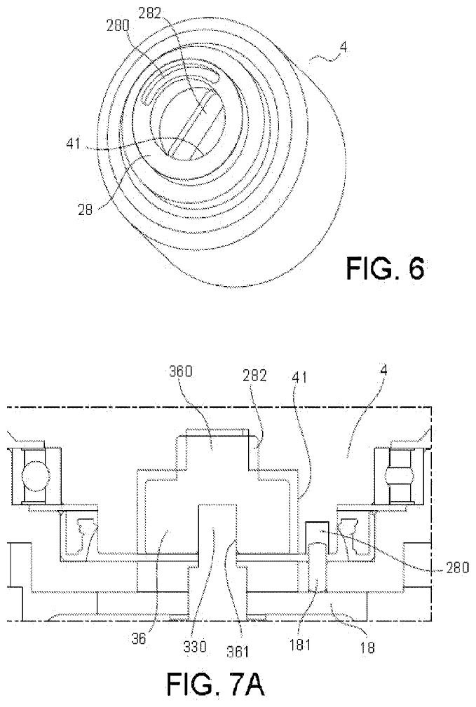

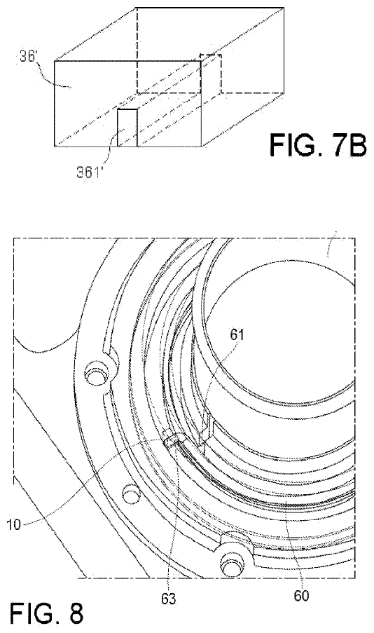

The coupling means 36 of a device as described above can have the shape(s) shown in FIGS. 1, 6, 7A, 7B: these means have for example the shape of a cylinder (FIG. 7A) in the lower part of which a groove 361 is produced which makes it possible to receive the end of the shaft 330 of the actuator 33 (see FIG. 1). The coupling part 36 is itself housed in a lower compartment 41 of the core 4 (see FIGS. 6 and 7A) and includes, in its upper part, a lug 360, for example having a parallelepiped shape, which makes it possible to actuate the core 4 in rotation when the shaft 330 actuates the part 36 also in rotation. Preferably, the groove 361 extends in a direction perpendicular to the lug, which makes it possible to compensate for or recover coaxiality or alignment defects along the 2 axes perpendicular to the axis of rotation XX′.

The lower compartment 41 of the core 4 has a complementary shape to that of the part 36: in particular, it includes 1 slot 282 (FIG. 7A) into which the lug 360 is inserted. Alternatively (see FIG. 7B), the coupling means 36′ have a parallelepiped shape in the lower part including a slot 361′ which makes it possible to receive the end of the shaft 330 of the actuator 33. This part 36′ is itself housed in the lower compartment 41 of the core 4 (see FIGS. 6 and 7B) which has a parallelepiped shape, so that, when the actuator 33 drives the part 36′ in rotation, the latter drives, in turn, the core 4 in rotation. Advantageously, the lower face 28 of the core 4 has a circular groove 280 (see FIGS. 1 and 6) that makes it possible to house a pin 181 connected to the motor cowl 18: this pin forms a stop for the movement of the core 4 when the latter is rotated by the actuator 33. The stop stops or limits the travel of the slot, in an initial position of the core, then in a maximum position thereof; the initial position may correspond to a flow of 0 in the outlet 20, the final position may correspond to a flow of 0 in the outlet 12.

According to another aspect of the invention, a return spring, for example a torsion spring, may be connected, via one of the ends thereof, to the core 4 and, via the other end thereof, to a portion which remains fixed when the core is driven in rotation, for example the hood or end piece 10. Thus, the actuator 33 may drive the core in rotation from a 1^{st} position to a 2^{nd} position, stopping the actuation of the actuator automatically causing the core to be returned to its 1^{st} position, or initial position. For example, the device can be in a rest position wherein the fluid flows towards the outlet 12, the actuator driving the core 4 towards a position wherein the fluid flows towards the outlet 20, the stoppage of the actuation of the actuator automatically causing a return of the core towards its initial position, that is to say towards the position wherein the fluid flows towards the outlet 12. This aspect of the invention is illustrated in FIG. 8, in which a torsion spring 60, one end 61 of which is connected to the upper part 30 of the core 4 and the other end 63 of which is connected to a lower part of the inlet cover 10, is visible.

The coupling means 36, and their housing in a lower compartment of the core 4, and/or the return means which have been described above in connection with FIGS. 6-8 may be applied not only to the distributor described above in connection with FIGS. 1-3 but also to any other distributor implementing a rotary element in a distribution body, in particular to any distributor:
including an injection of the fluid, not axially (along the axis XX′) as described above, but laterally to the body 2;
and/or for which the core includes a distribution channel of uniform cross-section and whose end located facing the outlet orifice(s) may have an elongated shape as described above or have a circular shape which corresponds to the cross-sections of the openings 12, 20.

Preferably, the case 2 is made of plastic material reducing the mass of the distributor, which is particularly favourable in the automotive field. Moreover, the plastic material is advantageously loaded with a material reducing friction. For example, the case is made of polyphthalamide, for example of the PA6T/61-GF30 type, very advantageously loaded with PTFE.

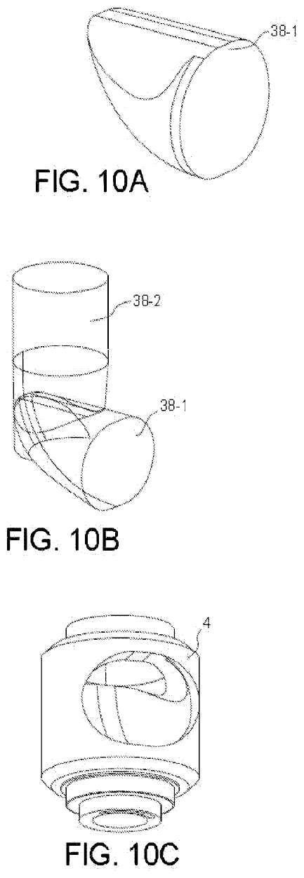

Furthermore, the case is preferably produced by injection moulding which simplifies its manufacture. With regard to the core, it is possible to create a shape of the inner duct 38, for example in 2 parts 38-1 and 38-2 as illustrated in FIGS. 10A and 10B, then mould the core by injection around this shape; in these figures, the shape in 2 parts 38-1 and 38-2 also has a cross-section that increases, but less progressively than in the case of FIG. 3.

FIG. 9A shows an embodiment of the assembly of the distributor of FIG. 1, after assembly. The references are those already described above in relation to FIG. 1. The coolant enters this device by the opening 11, according to the direction of the axis about which the rotation of the core is carried out by the actuator 33. The actuator is for example a gear motor MR, the output shaft of which is coupled to the core 4, for example as already described above. The gear motor is for example that described in the application WO2019/129984.

FIG. 9B shows an exploded view of the same assembly, with the seal 321 that ensures sealing with respect to the outlet passage 20, the liquid flowing towards the outlet passage 12.

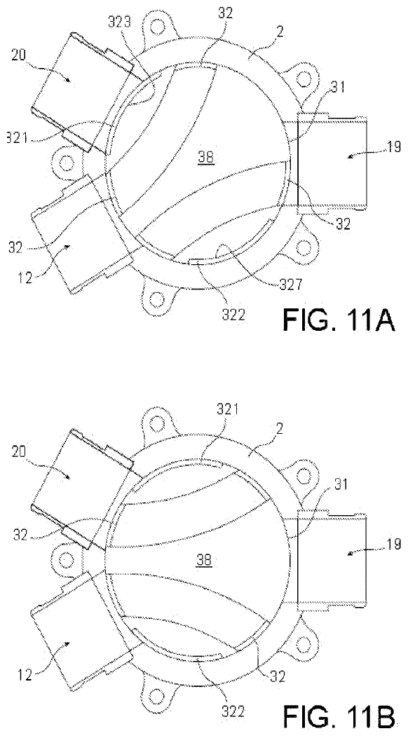

A core with its sealing means as described above can be applied not only to the distributors described above in relation to the previously commented figures, but also to any distributor implementing a rotary element in a distribution body, in particular to any distributor:
including an injection of the fluid, not in an axial manner (according to the axis XX′) as described above, but in a manner lateral to the body 2; in this case, the case and the core each have a fluid inlet in the lateral wall 8 and in the lateral surface 32, as explained in relation to FIGS. 11A-11B, described hereinafter;
and/or for which the core includes a distribution channel 38 having a uniform cross-section and the end of which, located facing the outlet orifice(s), can have an elongated shape as described above or have a circular shape which corresponds, or is identical, to the cross-sections of the openings 12, 20.

FIGS. 11A-11B show an application of the invention to a fluid injection, radially or laterally with respect to the body 2. In these figures, identical reference numerals from one figure to another refer to identical or corresponding elements.

FIGS. 11A, 11B are sectional top views of a radial-injection distributor. The inlet orifice 31 of the core is produced in the wall 38 and directs the fluid from this inlet orifice towards one of the 2 outlet orifices 12, 20, according to the rotation position of the core 4 in the case.

These figures show the seals 321, 322, the seal 321 in its housing 323 closing, in FIG. 11A, the outlet orifice 20, whereas the seal 322 is oriented towards a portion of the wall and therefore does not fulfil its function. These seals 321, 322, have the same structure and are produced in the same manner as above; in particular, each seal is formed in a corresponding housing 323, 327, with the description already made above applying.

The means for driving this lateral-injection distributor can be those described above, in particular in relation to FIGS. 1, 6-9A.

Here, as in the embodiment of FIGS. 5-5B, the duct 38 is wide, allowing a simultaneous supply of each of the outlet ducts 12, 20 (FIG. 11B). Alternatively, this duct can be narrower, allowing a supply of only one outlet duct at a time. Also alternatively, a distributor according to the invention can include one or more supply orifices, and/or one or more outlet orifice(s).

The operation of the distributor will now be described.

The supply inlet 11 is connected to a source of pressurised liquid, for example a pump connected to a liquid tank, and the two outlet orifices 12, 20 are connected for example to a thermal or electric motor to be cooled.

When it is desired to supply the outlet orifice 20 with a maximum flow rate, the core 4 is rotated about the axis X so as to position the outlet 34 of the core facing the outlet orifice 20. The pressurised liquid flows from the supply orifice 18 to the outlet orifice 20 through the conduit 38 as shown in FIG. 5A.

When it is desired to supply the outlet orifice 12 with a maximum flow rate, the core 4 is rotated about the axis XX′, so as to align the outlet 34 with the outlet orifice 20, the conduit 38 then connecting the supply orifice 11 and the outlet orifice 20, as shown in FIG. 5A.

As already explained above, the core 4 can take any intermediate angular position to ensure a proportional supply of the outlet orifices 12 and 20.

Other relative angular orientations of the outlets 12 and 20 are possible.

The invention makes it possible to provide a reliably operating dispenser while substantially relaxing the constraints on the dimensions, surface conditions, required materials and manufacturing methods.

The described example includes a supply orifice and two outlet orifices, but as mentioned above the present invention also applies to distributors including an inlet orifice and an outlet orifice, or a supply orifice and more than two outlet orifices, and to distributors including two supply orifices; a distributor according to the invention may include two axial fluid inlets, the actuator being able to be offset to enable the passage of fluid into the second end or more and one or more outlet orifices. The configurations with several supply orifices and several outlet orifices can implement cores with several cavities or recesses 43 to allow several flows simultaneously or not in the distributor.

The distributor, in particular associated with a gear motor, is particularly adapted to applications in the automotive field (thermal engine or electric engine) because of its reduced mass.

The distributor according to the present invention is suitable for equipping any vehicles with a thermal, hybrid or electric engine, implementing for example one or more temperature regulation system(s) and/or one or more air flow orientation system(s).

1. Hydraulic rotary distributor including a case and a core, said case comprising a lateral wall, two end walls defining a hydraulic chamber, wherein the core capable of rotating in said chamber about an axis of rotation is housed, at least one supply orifice, and at least one outlet orifice, which open(s) into the hydraulic chamber, the core including a lateral surface facing the lateral wall of the case, an inlet opening, at least one lateral outlet and a duct or a chamber that connects said inlet opening and said lateral outlet and that allows a supply of each of said outlet orifices according to the angular position of the core in the case, the core further including at least one seal for sealing between the lateral surface of the core and an outlet orifice of the lateral wall of the case, each seal being non-removable with respect to the core, each seal also including one or more fastening and/or injection lug(s) in the lateral surface of the core, said lugs forming one piece with the seal.

2. Hydraulic rotary distributor according to claim 1, wherein each seal is connected to, or is directly bonded with, the lateral surface of the core by chemical and/or mechanical bonding and/or integral with the core.

3. Hydraulic rotary distributor according to claim 1, each fastening and/or injection lug resulting from the same manufacturing method as the seal.

4. Hydraulic rotary distributor according to claim 1, wherein the lateral surface of the core includes at least one hollow housing, each containing or receiving said seal or one of said seal(s).

5. Hydraulic rotary distributor according to claim 4, wherein at least one housing includes a recessed zone, preferably disposed centrally with respect to the housing, located recessed with respect to the outer surface of the core, and which helps seal the outlet orifice.

6. Hydraulic rotary distributor according to claim 4, wherein at least one housing includes an element, referred to as holding element, extending from a bottom surface of the housing, preferably disposed centrally with respect to the latter, and helping hold the seal in the housing.

7. Hydraulic rotary distributor according to claim 1, the, or each, seal including a lip forming a closed contour and of minimal size greater than that of the outlet orifice to be sealed by the seal.

8. Hydraulic rotary distributor according to claim 1, wherein the case is made of plastic material.

9. Hydraulic rotary distributor according to claim 1, wherein:
each seal is made of a material capable of being used for an injection method, for example an elastomeric material;
and/or the core is made of thermoplastic material, of PPS (polyphenylene sulphide), or PA (polyamide) or POM (polyoxymethylene or polyformaldehyde or polyacetal), or PA66 (polyamide incorporating nylon) type.

10. Hydraulic rotary distributor according to claim 1, wherein said at least one supply orifice is in one of the end walls of the case and extends substantially perpendicularly to said axis of rotation.

11. Hydraulic rotary distributor according to claim 1, wherein said at least one supply orifice is in the lateral wall of the case.

12. Hydraulic rotary distributor according to claim 1, the lateral wall of the case including a plurality of outlet orifices, the core including a plurality of seals for sealing between the lateral surface of the core and one of the outlet orifices of the lateral wall of the case, each seal being non-removable with respect to the core and being disposed to seal one of the outlet orifices in a given position of the core.

13. Hydraulic rotary distributor according to claim 12, the lateral wall of the case including 2 outlet orifices, the core including 2 seals for sealing between the lateral surface of the core and one of the 2 outlet orifices of the lateral wall of the case, each seal being non-removable with respect to the core and being disposed to seal one of the 2 outlet orifices in a given position of the core.

14. Hydraulic rotary distributor according to claim 13, each of the 2 seals being disposed on one side of the lateral outlet of the core.

15. Hydraulic rotary solenoid distributor including a distributor according to claim 1 and an actuator driving the core in rotation.

16. Hydraulic rotary solenoid distributor according to claim 15, the actuator including an output shaft aligned along the axis of rotation.

17. Method for manufacturing a hydraulic rotary solenoid distributor according to claim 1, this method including:
a step of bi-material injection of an assembly including the core and the seal(s);
a step of introducing the core and the seal(s) into the case.

18. Method according to claim 17, wherein:
each seal is made of an elastomeric material;
and/or the core is made of thermoplastic material, of PPS (polyphenylene sulphide), or PA (polyamide) or POM (polyoxymethylene or polyformaldehyde or polyacetal), or PA66 (polyamide incorporating nylon) type.

19. Method for distributing a fluid using a hydraulic rotary solenoid distributor according to claim 15, the fluid being introduced by the supply orifice, and being guided by the inner duct of the core towards the lateral orifice of the latter then, according to the orientation of the core in the case, towards one and/or the other of the outlet orifices.

20. Method according to claim 19, the fluid being a mixture of water and of glycol or a coolant of a fuel cell.

21. (canceled)
